(19) United States
(12) Patent Application Publication
(10) Pub. No.: US 2006/0119571 A1
(43) Pub. Date: Jun. 8, 2006

(54) Device for controlling an apparatus

(75) Inventor: Peter Scheuering, Furth (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/211,993

(22) Filed: Aug. 25, 2005

(30) Foreign Application Priority Data
Aug. 25, 2004 (DE) 10 2004 041 182.4

(51) Int. Cl. G09G 5/00

(52) U.S. Cl. 345/156

(57) ABSTRACT

The invention relates to a device for operating a piece of apparatus, in particular for controlling X-ray equipment, whereby said device has an eye control.

The invention relates to a device for operating a piece of apparatus, in particular for controlling x-ray equipment.

With x-ray equipment especially, there exists the problem of operating the equipment on the one hand and at the same time paying attention to the patient. There, for example, two hands are needed to push an intercardiac catheter and another hand or a foot to operate the x-ray emitter, which unit should remain switched on for as short a time as absolutely possible because of the harmful effect on operator and patient. Moreover, it may be that the position of the emitter unit has to be adjusted, the contrast medium injected etc.

In addition to remote control panels, so that, for example, a medical technician can carry out the necessary commands instead of a doctor, and foot actuated pedals, which complement the hands, voice controls have already been considered, but have not yet passed the trial stage.

From DE 296 19 277 U1 a device for operating a piece of apparatus is already known, with which device control commands on a monitor can be selected by means of movements of the head, whereby the head is observed by a camera and the relevant head position results in the selection of the individual commands on the monitor. This system has the disadvantage that, in many cases, because of the x-ray apparatus on the one hand and other machines used there, there is no room available to allow the head of the doctor to be captured properly by means of such a camera and, moreover, it is, of course, also impractical if the doctor has to nod or turn his head just to give certain commands, while at the same moment he might have to observe something on the patient in exactly the opposite direction, and, therefore, there is no way he can turn his head in the direction that would be necessary to select the command to control the apparatus.

The invention is based, therefore, on the task of creating a device for operating a piece of apparatus, in particular for controlling X-ray equipment, for the operation of which device one does not need one's hands at all, so that one's hands remain free for other activities especially on the patient.

To achieve this object, according to the invention the device for operating a piece of apparatus has an eye control, for example, in such a way that a there is a monitor on which a menu for control commands and a cursor can be reproduced with the help of electronics, in which sensors are used to capture movements of at least one eye of the operator, which sensors feed the corresponding signals to the electronics, so that the cursor can be adjusted on the screen of the monitor according to these movements.

A further possibility of the design of an eye control for activating x-ray equipment is characterised by a display with “line of vision” recognition, as described for instance by Jacques R. Charlier from the Institut de Technologie Medicale, CHRU de LILLE, which determines by means of automatic pattern recognition which illustrated or captioned section of the display the observer, whose eyes are being automatically probed, is aiming at.

A pair of glasses can also be used to particular advantage in order to implement an eye control, such as has become known from the disabled work to control actions by eye. Thereby, such a pair of glasses has a transmitted light screen with distributed LCD elements of different colours and/or shapes, which elements are mapped onto the retina of the eye by means of a special lens and to which elements sensors are assigned in order to determine the element that has just been fixed on.

This use of a pair of glasses has yet another advantage in that the eye control function can be integrated into lead glass glasses, which are frequently used when working with X-ray equipment.

In a development of the invention the control device can in this case be designed in such a way that the respective control command is carried out when it is fixed by the observer for a predetermined period of time, e.g. 200 ms. As long as the apparatus operator is looking for the correct command and, therefore, the eyes wander about and only very briefly rest on the one or other command, nothing at all will happen yet, it is not until the command that is actually to be carried out is found and the eyes fix on this command for a certain length of time, that this command is carried out automatically.

To particular advantage the design is effected in such a way that both eyes are scanned and commands are only carried out if both eyes fix on the same point. This also creates an additional safeguard that prevents the possibility of unwanted control commands being carried out.

With all options of realising an eye control, however, there also still naturally remains, as before, the possibility that the actual execute command, after it has been first selected by means of eye control, is then triggered to execute by a foot-actuated pedal.

Further advantages, features and details of the invention can emerge from the following description of the invention with reference to two exemplary embodiments.

The first exemplary embodiment relates to a pair of glasses known from the disabled work, which glasses have a transmitted light screen and two eye sensors.

First the transmitted light screen lets the picture, which the eye would see even without glasses, pass through, in order to ensure normal eyesight. Logically, these glasses can also be provided with a lens, which corrects any defective vision there might be in the same way as a normal pair of glasses. The conventional lead glass glasses that doctors often wear when in the vicinity of the X-ray equipment can also be converted to such remote control glasses.

Several LCD elements of different colours and/or shapes are introduced into the transmitted light part, which elements are mapped in high definition onto the retina of the eye by means of a special lens. A sensor sits behind each of these elements, which determines whether the eye is fixing on this exact point. Should this be the case for both eyes, i.e. does the corresponding sensor feel that it is being “looked at” on both transmitted light parts, and this for longer than a certain time in the adjustable grid of 100 to 300 ms, then a programmed function linked to it is triggered. Thus it is possible to trigger a function of the equipment within 200 ms by simply fixing the eyes. The glasses themselves transmit their pulses to the control unit of the equipment by means of Bluetooth or another modern wireless protocol.

The advantage of this eye control device using a pair of glasses is that the hands remain free, there are no troublesome cables for the remote control present and because the glasses are permanently on the person, there is also no longer the well-known problem of “Can't find them” as usually occurs with IR transmitters. Furthermore, the operation can be implemented very.

Instead of a pair of glasses, it is also possible to use a display with “line of vision” recognition, as described for instance by Jacques R. Charlier from the Institut de Technologie Médicale, CHRU de LILLE. By means of automatic pattern recognition said display permits the identification of which of several parts of the display, captioned or illustrated or set with pictures, a person is looking at. This device constantly looks for the head of a person and when the device has found the head, said device looks for the two eyes in the head and then tracks the eyes continuously. Hence it is known exactly what the two eyes are dwelling on in practically every deci-second. If both eyes are looking at a part of the display, which display can, for example, still distinguish 16 different commands on a 20″ monitor at a distance of 3 meters, then it executes the relevant command.

### DEVICE FOR CONTROLLING AN APPARATUS

### CROSS REFERENCE TO RELATED APPLICATIONS

This application claims priority to the German application No. 10 2004 041 182.4, filed Aug. 25, 2004 which is incorporated by reference herein in its entirety.

### FIELD OF INVENTION

The invention relates to a device for operating a piece of apparatus, in particular for controlling x-ray equipment.

### BACKGROUND OF INVENTION

With x-ray equipment especially, there exists the problem of operating the equipment on the one hand and at the same time paying attention to the patient. There, for example, two hands are needed to push an intercardiac catheter and another hand or a foot to operate the x ray emitter, which unit should remain switched on for as short a time as absolutely possible because of the harmful effect on operator and patient. Moreover, it may be that the position of the emitter unit has to be adjusted, the contrast medium injected etc.

### SUMMARY OF INVENTION

In addition to remote control panels, so that, for example, a medical technician can carry out the necessary commands instead of a doctor, and foot actuated pedals, which complement the hands, voice controls have already been considered, but have not yet passed the trial stage.

From DE 296 19 277 U1 a device for operating a piece of apparatus is already known, with which device control commands on a monitor can be selected by means of movements of the head, whereby the head is observed by a camera and the relevant head position results in the selection of the individual commands on the monitor. This system has the disadvantage that, in many cases, because of the x-ray apparatus on the one hand and other machines used there, there is no room available to allow the head of the doctor to be captured properly by means of such a camera and, moreover, it is, of course, also impractical if the doctor has to nod or turn his head just to give certain commands, while at the same moment he might have to observe something on the patient in exactly the opposite direction, and, therefore, there is no way he can turn his head in the direction that would be necessary to select the command to control the apparatus.

The invention is based, therefore, on the task of creating a device for operating a piece of apparatus, in particular for controlling X-ray equipment, for the operation of which device one does not need one's hands at all, so that one's hands remain free for other activities especially on the patient.

To achieve this object, according to the invention the device for operating a piece of apparatus has an eye control, for example, in such a way that a there is a monitor on which a menu for control commands and a cursor can be reproduced with the help of electronics, in which sensors are used to capture movements of at least one eye of the operator, which sensors feed the corresponding signals to the electronics, so that the cursor can be adjusted on the screen of the monitor according to these movements.

A further possibility of the design of an eye control for activating x-ray equipment is characterised by a display with “line of vision” recognition, as described for instance by Jacques R. Charlier from the Institut de Technologie Medicale, CHRU de LILLE, which determines by means of automatic pattern recognition which illustrated or captioned section of the display the observer, whose eyes are being automatically probed, is aiming at.

A pair of glasses can also be used to particular advantage in order to implement an eye control, such as has become known from the disabled work to control actions by eye. Thereby, such a pair of glasses has a transmitted light screen with distributed LCD elements of different colours and/or shapes, which elements are mapped onto the retina of the eye by means of a special lens and to which elements sensors are assigned in order to determine the element that has just been fixed on.

This use of a pair of glasses has yet another advantage in that the eye control function can be integrated into lead glass glasses, which are frequently u sed when working with X-ray equipment.

In a development of the invention the control device can in this case be designed in such a way that the respective control command is carried out when it is fixed by the observer for a predetermined period of time, e.g. 200 ms. As long as the apparatus operator is looking for the correct command and, therefore, the eyes wander about and only very briefly rest on the one or other command, nothing at all will happen yet, it is not until the command that is actually to be carried out is found and the eyes fix on this command for a certain length of time, that this command is carried out automatically.

To particular advantage the design is effected in such a way that both eyes are scanned and commands are only carried out if both eyes fix on the same point. This also creates an additional safeguard that prevents the possibility of unwanted control commands being carried out.

With all options of realising an eye control, however, there also still naturally remains, as before, the possibility that the actual execute command, after it has been first selected by means of eye control, is then triggered to execute by a foot-actuated pedal.

Further advantages, features and details of the invention can emerge from the following description of the invention with reference to two exemplary embodiments.

The first exemplary embodiment relates to a pair of glasses known from the disabled work, which glasses have a transmitted light screen and two eye sensors.

First the transmitted light screen lets the picture, which the eye would see even without glasses, pass through, in order to ensure normal eyesight. Logically, these glasses can also be provided with a lens, which corrects any defective vision there might be in the same way as a normal pair of glasses. The conventional lead glass glasses that doctors often wear when in the vicinity of the X-ray equipment can also be converted to such remote control glasses.

Several LCD elements of different colours and/or shapes are introduced into the transmitted light part, which elements are mapped in high definition onto the retina of the eye by means of a special lens. A sensor sits behind each of these elements, which determines whether the eye is fixing on this exact point. Should th is be the case for both eyes, i.e. does the corresponding sensor feel that it is being “looked at” on both transmitted light parts, and this for longer than a certain time in the adjustable grid of 100 to 300 ms, then a programmed function linked to it is triggered. Thus it is possible to trigger a function of the equipment within 200 ms by simply fixing the eyes. The glasses themselves transmit their pulses to the control unit of the equipment by means of Bluetooth or another modern wireless protocol.

The advantage of this eye control device using a pair of glasses is that the hands remain free, there are no troublesome cables for the remote control present and because the glasses are permanently on the person, there is also no longer the well-known problem of “Can't find them” as usually occurs with IR transmitters. Furthermore, the operation can be implemented very.

Instead of a pair of glasses, it is also possible to use a display with “line of vision” recognition, as described for instance by Jacques R. Charlier from the Institut de Technologie Medicale, CHRU de LILLE. By means of automatic pattern recognition said display permits the identification of which of several parts of the display, captioned or illustrated or set with pictures, a person is looking at. This device constantly looks for the head of a person and when the device has found the head, said device looks for the two eyes in the head and then tracks the eyes continuously. Hence it is known exactly what the two eyes are dwelling on in practically every deci-second. If both eyes are looking at a part of the display, which display can, for example, still distinguish 16 different commands on a 20″ monitor at a distance of 3 meters, then it executes the relevant command.

1.-7. (canceled)

8. A device for operating an apparatus, comprising a control unit operatively connected to the apparatus, the control unit configured to acquire and transform eye movements of at least one eye of a user of the apparatus into at least one control command for the apparatus.

9. The device according to claim 8, wherein the device is an operating device for an x-ray apparatus.

10. The device according to claim 8, further comprising:
a monitor for displaying a menu including the at least one control command and a cursor; and
a plurality of first sensors for acquiring the eye movements, wherein the control unit is configured to move the cursor on the monitor according to the acquired eye movements.

11. The device according to claim 8, further comprising a display device including a plurality of sections having picture icons or texts, the display device configured to determine on which of the sections the user focuses at a given moment while operating the apparatus by scanning the at least one eye and by using a pattern recognition mechanism.

12. The device according to claim 8, further comprising a pair of glasses having a transmitted light screen and distributed LCD elements, the distributed LCD elements configured to generate and map a plurality of colors and/or shapes onto the retina of the at least one eye using an optical lens, wherein a plurality of second sensors is assigned to the LCD elements for determining on which of the LCD elements the user focuses at a given moment while operating the apparatus.

13. The device according to claim 12, wherein the pair of glasses are a pair of lead glasses.

14. The device according to claim 8, wherein the control unit is adapted to the execute the control command only after the user has focused on a display area related to the control command for a minimum period of time without moving the eye.

15. The device according to claim 14, wherein the minimum period of time is 200 ms.

16. The device according to claim 8, wherein both eyes of the user are scanned for acquiring the eye movements, and the control commands is executed only if both eyes are focused on a common focus point.
